(19) United States
(12) Patent Application Publication
(10) Pub. No.: US 2019/0221198 A1
(43) Pub. Date: Jul. 18, 2019

(54) Finger Connecting Flute Attachment

(71) Applicant: David Garland Harris, Manlius, NY (US)

(72) Inventor: David Garland Harris, Manlius, NY (US)

(21) Appl. No.: 15/870,980

(22) Filed: Jan. 14, 2018

(51) Int. Cl. G10G 5/00; G10D 7/02

(52) U.S. Cl. CPC G10G 5/005; G10D 7/026

(57) ABSTRACT

The instant invention relates to new attachments for the round tubular body of flutes. It firmly, but easily and removably, affixes the flute to the player's left index finger (and/or thumb) so that the flute is stabilized without pressure on the player's lower lip. Thus, it enhances the flexibility of the player's lips so as to more perfectly play the flute while also more exactly and repeatedly locating the player's fingers on the flute, while preventing inadvertent rotation of the flute. This is especially beneficial for the player's lower lip, which, under extant art, is forcibly pinned against the lower teeth and gums so as to stabilize the flute. This benefit is achieved by completely stabilizing the flute in the player's hands by firmly connecting the flute to the player's finger (and/or thumb) with a finger retainer incorporating an opening through which the flute player's left index finger (and/or thumb) is inserted, like wearing a ring.

In the preferred embodiment, the finger retainer is a ring-like structure built into the flute-finger connector and for economy this system is hereafter referred to as a ring. The use of a ring provides a firm connection between the player's fingers, the flute-finger connector and the flute permitting the left index finger and right thumb to completely stabilize the instrument with no pressure on the player's lips whatsoever, while completely preventing inadvertent rotation of the flute.

One benefit of the instant invention over extant art is its flexibility with respect to the types of flutes it may be connected to. In one embodiment, attachment to the flute body is by an extraneous, extant, devices, such as cable ties, hook and loop, etc., which are adjustable and flexible so as to permit attachment of the device to tubular body flutes of widely varying cross-sectional dimensions, such as alto, bass, piccolo and treble flutes, as well as the more common C flute. Thus, a player could invest substantially in a device made of high-quality material, such gold with precious stones, assured of their ability to easily move it from flute to flute and between any number of different types of flutes.

A second benefit of the instant invention over extant art is that a player can use it without altering their hand position from how they would play the flute without the device. The absence of any pad between the ring and the body of the flute means that the player's left hand index finger rests directly on the body of the flute, exactly the same as it would rest on the flute absent the invention. Thus, this invention requires no adjustment to the player's style of playing whatsoever, except that it enhances the stability of the flute and allows it to be played with any amount of pressure on the player's lower lip, including none.

Another very substantial benefit of the instant invention over extant art is that it allows the flute to be safely played by growing children without fear of distorting the proper development of their gums and teeth. Many parents permit their children to start their music education only with a piano or a stringed-instrument because wind instruments have a tendency to put severe stress and strain on the mouth, teeth and gums, which can distort their development. Because the instant invention permits, even encourages, use of the flute without strong, or even any, pressure on the teeth and gums, a flute so equipped can be used even by young children without orthodontia concerns.

### CROSS-REFERENCE TO RELATED APPLICATIONS

This application claims the benefits and priority of Provisional Patent Application 62/446,407, filed at 16:25:14 EST on 14 Jan. 2017, by the present inventor, which is incorporated by reference.

### FEDERALLY SPONSORED RESEARCH

None.

### SEQUENCE LISTING

None.

### BACKGROUND ART

A recurring problem in playing the flute is the awkward positioning required of the hands and fingers for proper control and operation of the musical instrument, which has an innate tendency to roll because of imbalance from the weight of the keys and other parts of the flute's operating system. Because the player must rapidly shift fingerings between all keys of the flute being depressed to some or all keys being open, producing radically changing support of the flute from the player's fingers, the stability of the flute is imperiled. This instability is reflected both in the difficulty of maintaining the ideal relation between the lips and the flute so as to produce the most perfectly formed notes and in the difficulty of changing fingerings quickly and reliably while also preventing the flute's rolling away from its ideal position.

Per the current state of the art, to stabilize the flute the digits of the right hand press the flute outward, away from the player's body, which, via the base of the left hand index finger acting as a fulcrum, transfers pressure to the player's lower lip. To hold the flute so as to avoid untoward movement of the instrument considerable pressure must be exerted. Maintaining such substantial, constant, balanced, stabilizing pressure, given the rapid and extreme variations in support provided by the player's fingers as different notes are played, is problematic and not always successfully accomplished, leading to the flute rolling about, and incorrect and/or poor quality notes being played.

A variety of hand-positioning techniques are advocated in the literature for better stabilizing the flute against unintended rolling, such as the Rockstro hand position. None of these prescriptions serve other than to reduce the flute's instability a bit, and a serious drawback of current flute playing techniques and all extant prescriptions for mitigating this difficulty is the need for substantial pressure to be exerted by the flute's mouthpiece against the player's lower lip. For example, the Rockstro hand position is based on considerable additional pressure being applied by the player's right thumb to the side of the flute nearest the player, more forcefully leveraging it against the fulcrum of the base of the left hand index finger, which contacts the flute's side furthest from the player, creating substantial pressure against the player's lower lip sufficient to more firmly fix the position of the flute and reduce its rolling in the player's hands. Such hand positions evidence several problems. First, they require an awkward and unnatural positioning of the thumb. The thumb is much more naturally positioned on the bottom of the flute than against its side, which can be done with this invention without any loss of control of the flute. Second, such hand positions require substantial steady pressure, which is difficult to maintain when moving the other fingers of the right hand, and which is exacerbated by the fatiguing hand position noted above. Third, the substantial pressure against the base of finger of the left hand is painful and fatiguing after a time, both limiting continuous practice and performance time and being a cause of playing errors. The necessary pressure is so great that it is common, if not universal, among experienced flute players for a substantial callus to form on their left hand at the point where the base of index finger presses against the flute. Fourth, and most problematic, such hand positions rely upon even greater pressure being applied by the flute to the player's lower lip, limiting the flexibility of the lips to shape and form notes in the most ideal way, which is especially problematic given the need of a flute player to widely, flexibly and quickly alter the shape of their lips, their embouchure, to best play all of the notes of the flute.

The provision of solid, stable flute-finger and flute-thumb connectors, finger retainers, permits much more stable and certain control of the flute while playing, no matter the complexity of fingering any sequence of notes. When using both the index finger and right thumb connectors it is possible to operate the and control the position of the flute with no pressure on the lower lip or the base of the left hand index finger whatsoever and with no other body parts of the player in contact with the instrument. This stabilizing support being independent of operating the flute permits finger changes for any sequence of notes with little or no effect on the stability of the flute or its relation to the player's lips.

Separating the amount of pressure applied to the player's lower lip from operating, controlling, and stabilizing the flute permits the player to completely flexibly employ both the lower lip and the upper lip so as to create the most pleasing notes possible. Even beyond this very substantial benefit is the effect of the instant invention of providing absolutely greater stability and control of the instrument, thereby facilitating quicker, more accurate and more consistent complex fingering changes both by reducing pressure on critical fingers and by generally increasing the stability of the instrument in the player's hands. Similarly, with less pressure required, playing the flute for an extended time period is less fatiguing and painful. Also, provision of a ring allows more consistent, repeatable and quickly attained positioning of the hands on the flute; one need only put one's left hand index finger into the ring to quickly locate the left hand in exactly the same, consistent, and correct position.

This additional stabilizing support does more than prevent rotation. It also provides material support in the vertical and horizontal dimensions, as shown by the ability of one to hold and operate a flute with this device without any contact with their lips.

Another very substantial benefit of the instant invention over extant art is that it allows the flute to be safely played by children without fear of distorting the proper development of their gums and teeth. Many parents permit their children to start their music education only with a piano or a stringed-instrument because wind instruments generally put severe stress and strain on the mouth, teeth and gums, which can distort their development. Because the instant invention permits, even encourages, playing the flute without strong, or even any, pressure on the teeth and gums, a flute so equipped can be used even by young children without orthodontia concerns.

The current invention provides for no spacing between or offsetting of the player's fingers and the body of the flute, in contrast to, for example, Peplowski (below). The finger retainer is discontinuous, evidencing a gap at the bottom of the ring. This feature retains the original diameter of the flute in contact with the player's left hand index finger so that a player may shift between a flute with and without the device with no noticeable change in their fingers' positions on the instrument. This allows a player to adopt this enhancement without any change in their technique. Also, this design, coupled with flexibly adjustable attachments, described below, allows this device to be interchangeably attached to any flute no matter its diameter, such as treble, alto, bass, and wooden flutes, as well as to related instruments such as piccolos and other transversely played instruments.

Harris, provisional patent application No. 62446401, discloses an invention comprising a finger (and/or thumb) finger retainer mounted on a spacer of some positive thickness such that the angle of the player's hand, in relation to the flute, is adjusted to a more natural, less bent, position. In contrast, the instant device omits any spacer and the player's left hand index finger rests directly on the flute and in the same relation to the flute as if the invention were absent. As flutes are not commonly produced with built-in spacers (which were more common a number of years ago when flute players were transitioning from the thicker wooden flutes to the thinner silver ones) and as all players do not purchase after-market spacers for this purpose, clearly, the greatest demand exists for flutes of thinner circumference, consistent with their thinner tubular metal construction materials. The instant invention accommodates this demand by omitting the spacer so that players may continue to hold their flutes exactly as they have learned to do, while, at the same time, providing the substantial benefits of greatly increased flute stability and the elimination of the need for pressure to be applied by the mouthpiece of the flute to the player's lower lip.

Tanabe, U.S. Pat. No. 8,269,086 B1, provides a ring for the player's finger with friction pads that touch the flute. However, this device only helps to create some additional friction between the player's hand and the flute, but does not serve to fix that relation in any definite or necessary way, and neither does it reduce substantially the pressure against the player's lower lip needed to stabilize the flute. For example, the device described herein makes the flute so stable that a player can hold the flute utilizing only the left hand index finger and ring and the thumb of the right hand, and without touching the flute to their chin or lips, as the current invention allows the player to support the flute without the use of any other fingers or pressure points. Additionally, Tanabe's device does not establish the consistent placement of the player's hand in relation to the flute because it is not fixed to the flute, but only to the player's hands. Because the flute-finger connector remains firmly affixed to the flute when the player removes their hands, the flute can be re-deployed instantly by merely inserting the correct digits into the ring-openings and playing.

Peplowski, U.S. Pat. No. 4,763,556 provides a rest and spacer for the index finger of the left hand and a similar rest for the thumb of the right hand. Ho Fan Lee, patent application Ser. No. 11/349,197, provides a somewhat similar device to that of Peplowski, but with a small amount of additional support for the thumb of the right hand. While both devices assist in proper placement of the hands, and in permitting better playing, neither addresses the inherent instability of the flute caused by the various shifting fingerings and the lack of secure connection between the player and the flute which results in the flute rolling about as the player changes fingerings to produce various notes. Thus, the current invention differs from these both by provision of a stability enhancing connecting device between the player's digits and flute and by omitting any spacer.

Harris, provisional patent application No. 62446394, discloses an invention comprising a tubular flute which is manufactured with a similar flute-finger connector. This differs materially from the instant invention in that it does nothing to address the issue of extant flutes' lack of such support because it does not provide for a stand-alone ring attachment device that can be removably affixed to existing flutes.

Guenther, U.S. Pat. No. 444,830 A shows a vertically-played flute with hooks provided for the player's thumbs so as to better hold the flute in that position. This arrangement is common for vertically-played instruments such as clarinets, bassoons, etc. The instant invention is quite novel with respect to these devices as they would not function as it does with a transversely played flute. They serve only to prevent the downward movement of an instrument when it is held vertically and would serve no purpose with a transverse instrument.

### OBJECT OF THE INVENTION

It is therefore an object of the present invention to provide new attachments for the tubular body of flutes which permits stabilizing the flute without undue, or even any, pressure on the player's lower lip and also facilitating complex fingering changes while also allowing its adoption without any revision to the player's playing technique.

### DISCLOSURE OF THE INVENTION

To accomplish these results, the flute-finger connector, in the preferred embodiment, provides a fixed, but removable, attachment part of a clip of shape retaining material such as spring metal or plastic or elastic bands which can partially or fully encircle the body of the round tubular flute around where a flute player's left hand index finger rests against the flute body when playing it. The resilient clip is formed with a finger connecting part, a finger retainer, such as a ring-like opening for the finger, either the index finger of the left hand or the thumb of the right hand. The partially encircling arms of the flute attachment part are spaced to conform with flute design and permit firm attachment of the device without interfering with the normal operation of the instrument, and with a finger retaining partial ring built into it, which is discontinuous with a gap where the device contacts the body of the flute about where the player's left hand index finger rests against the instrument while playing, properly located and set at an appropriate angle for increased flute stabilization and comfortable, effective index finger function.

With a properly fitted and located finger-retainer, the left hand index finger is free to perform its multiple functions of pivot point, pressure point, and upper C key operation, while also providing great stability and resistance to inadvertent rotation of the flute because of the additional anti-rotational force applied to the flute by the player's left hand index finger via its connection to the device by its the ring-like finger retainer.

The invention may be formed as an integral piece of, for example, molded, relatively soft but elastic plastic with good memory such as PVC plastic which does not mar the surfaces of the flute.

According to another embodiment, attachment could be accomplished with integral pinch-type clamps where the ends are squeezed to relieve its pressure so that the clamps can be affixed to the body of the flute. Also, the device can be made without any integral attachment parts so as to be attached to a flute with extraneous, extant, adjustable-length attachments, such as cable ties, hook and loop straps, or elastic bands which encircle the circumference of the tubular flute body and which would permit the same device to be used interchangeably on any transverse instrument of any diameter. Also, when the spacing bars of the device are of appropriate length, the wire ties, etc. attachments can be fastened to the flute at various points so as to accommodate a wide variety of configurations such as special keys like a C#, or a G-A trill key. This also permits easy transfer of the invention between different kinds of transverse instruments, such as piccolos and alto and bass flutes, by allowing for differing attachment points consistent with their different key configurations.

The device also can be similarly constructed and arranged for fastening onto the undersurface of the round tubular flute body between the E and F tone holes of the flute. In this example, the device is positioned on the undersurface of the tubular flute body where the right thumb of a flute player rests against the flute when playing it. An appropriate discontinuous ring or other finger retainer, such as a clip into which the tip of the thumb may be inserted, is attached so as to anchor the flute with the thumb in a natural position.

### BRIEF DESCRIPTION OF THE DRAWINGS

FIG. 1 is a side view of the device, showing its components; the finger retainer, which here is shown as a discontinuous ring, spacing bars that locate the ring and attachment arms in relation to one another, and attachment arms.

FIG. 2 is an environmental perspective view of the device in FIG. 1.

FIG. 3 is a view from above of the flute with the device shown in FIG. 1 attached to it.

FIG. 4 is a view from below the flute with the device shown in FIG. 1 attached to it.

FIG. 5 is an environmental perspective view of the device in an embodiment without an integral flute connecting part, but only with a discontinuous finger retaining ring and spacing bars. This example could be fixedly, but removably, attached to any transverse instrument with any of a variety of known attachment devices. For example, hook and loop, peg and hole or cable tie fasteners could attach the device to a flute by tightly encircling the spacing bars of the device and the body of the flute at appropriate points between the keys. This example is very flexible in that the spacing bars can be made of a length such that the encircling fasteners can cross the attachment arms at many different points, encircling flutes at many locations, and conforming to the key arrangements of virtually any instrument. This design permits the device to be used on an instrument of any diameter and also provides the maximum amount of flexibility in terms of conforming to the widest variety of hands and hand positions as well as variations in flute's diameters, lengths, key configurations, etc.

FIG. 6 is a perspective view of the flute in the player's hands with an embodiment of the device shown that wraps, in serpentine fashion, around the player's left hand index finger and around the flute with a removable elastic band.

FIG. 7 is a view from the side of the device shown in FIG. 6 attached to a flute shown in cross section.

FIG. 8 is a detail view of a portion of the device shown in FIG. 7 that displays particularly the elastic band and peg that attach the device to the flute by fastening back onto the device after wrapping around the flute.

FIG. 9 is a view of the player's hand with the device connected thereto by a serpentine partial loop, which provides a perspective view of the device in an embodiment with attachment to the flute by an elastic memory-retaining material attachment part, which is partially flute-encircling, and a clear view of how it is used.

FIG. 10 is a side view of the device shown in FIG. 9 attached to a flute shown in cross section.

FIG. 11 is an environmental perspective view, similar to that shown of the device in FIG. 3, but with elastic bands and pegs on the spacing bars for mounting it to the flute. The spacing bars of this embodiment can be made longer and provided with a number of attachment pegs, so as to allow the device to be attached to flutes with varying body diameters and key configurations.

FIG. 12 is an environmental perspective view of the device as in FIG. 11, but with only one spacing bar and a finger retaining partial ring, which also can be mounted to the flute with elastic bands, as noted above, in the description of FIG. 11, which can have a spacing bar of differing length with several pegs, so as to provide additional flexibility. Similarly, the partial ring shown can be made more complete and its circumference extended so as to contact, or nearly contact, the body of the flute. It also can be made with no integral provision for attachment, and fastened to the flute with any extant, known encircling fastener, such as described above with respect to FIG. 3.

FIG. 13 shows several views of partial rings made of memory-retaining material that can be fit into the opening of a finger retainer so as to reduce its diameter. Thus, these rings permit adjusting the flute-finger connector so as to fit a wide variety of players.

### DESCRIPTION OF PREFERRED EXAMPLE EMBODIMENTS AND BEST MODE OF THE INVENTION

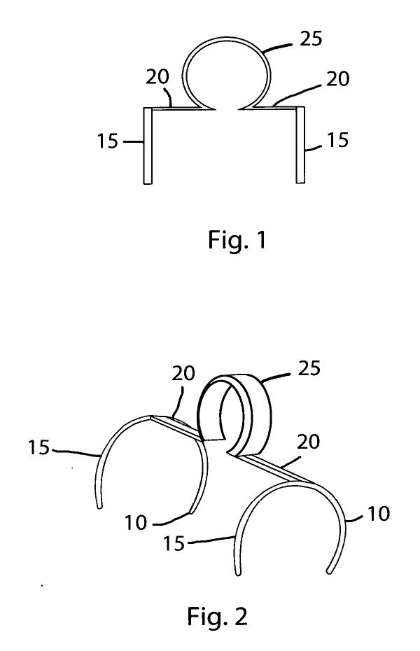

FIG. 1 is a side view of the left hand index finger flute-finger connector comprising a finger-retaining discontinuous ring, 25, attachment arms (upper only are shown), 15, and spacing bars, 20, connecting the parts together and determining where the fastening will take place with respect to the keys of a flute, and of such length as to permit the device's attachment to the flute without interfering with the action of its keys. This same embodiment is shown in FIG. 2, in environmental perspective view, which shows, in addition to the parts described before, the lower attachment arms, 10.

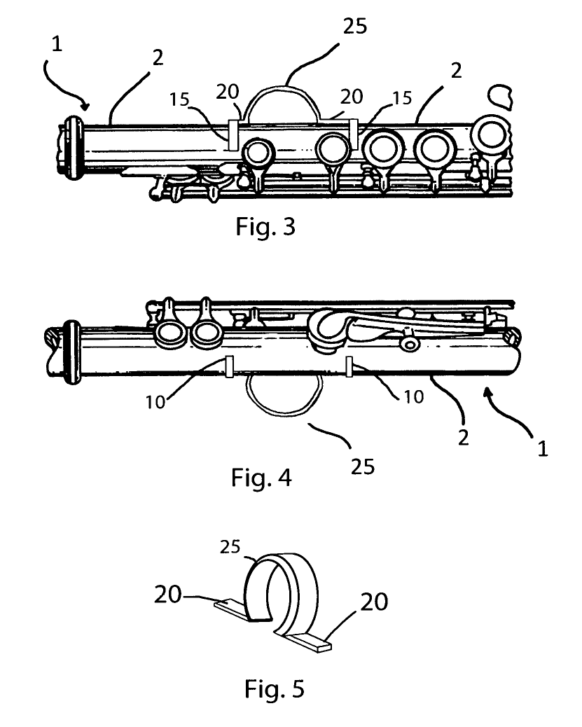

A left hand index flute-finger connector comprising a finger-retaining discontinuous ring, 25, is shown in FIG. 3 and FIG. 4, removably attached to the tubular body, 2, of the flute, 1, by its pairs of upper, 15 in FIG. 4, and lower, 10 in FIG. 5, attachment arms. The spacing of the attachment arms, 15 and 10, relative to the ring, 25, and the flute, 1, is controlled by the lengths of the left and right spacing bars, 20, which can be of varied, equal or asymmetrical length, as required to best fit the flute and the player so as to provide support for the flute, but not impeding its function and proper operation.

FIG. 5 shows an environmental perspective view of the flute-finger connector comprising a finger retainer, 25, and spacing bars, 20. This embodiment of the invention omits integral flute attachment parts in favor of independent, external, extant, alternative detachable attachment devices. This embodiment of the flute-finger connector can be affixed to the flute by, for example, hook and loop, peg and hole, cable tie, etc. The flexibility of attaching the device via extraneous devices allows great variation in locating the device on the flute and in affixing it to the widest possible variety of flutes and transversely played instruments, which can also be facilitated by providing spacing bars of sufficient length so as to accommodate a wide variety of instruments and differing key configurations. The lengths of the sides of the spacing bars (which need not be equal) coupled with a broad selection of attachment devices of varying lengths and widths also allows for the greatest possible number of different locations of the device on the flute so as to best accommodate the widest variety of players' hands.

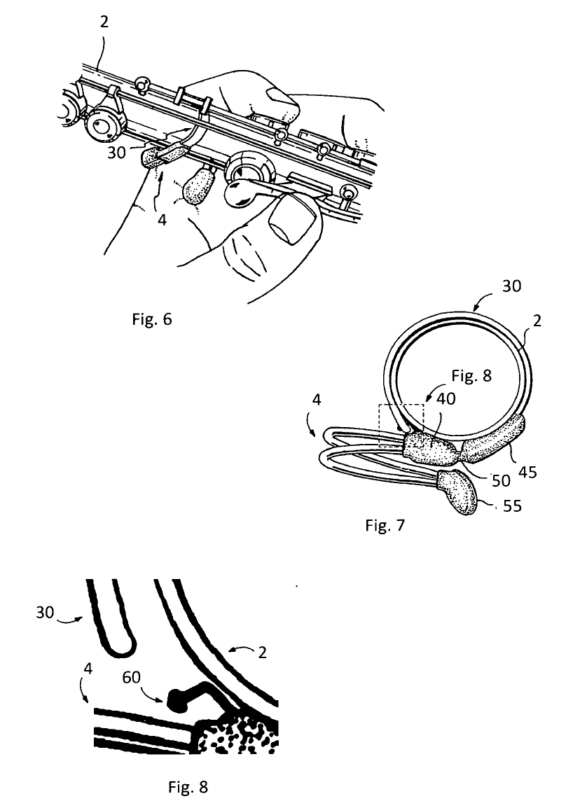

FIG. 6 is a perspective view of the device in use by a player who is holding a tubular body flute with another embodiment of the flute-finger connector attached to it and connected to his left hand index finger via a discontinuous ring-like opening, 4, created by its serpentine winding around the player's finger. Said device is attached to the flute by attachment parts fully encircling the flute, 30. FIG. 7 is a detailed view of the device in FIG. 6, showing a side view of the device attached to the flute, 2. The pads, 40 and 45, provide additional friction between the flute and device, which, when coupled with tension-force applied by the elastic band, 30, retain the device and the flute in a fixed relation to one another. There is a joint, 50, that can be bent as necessary to assure that the tension-applying elastic band, 30, can be drawn around the circumference of the flute so as not to interfere with the operation of any of the keys of the flute, while permitting the player's index finger to be comfortably positioned. The finger-connecting part of the device, 4, is ring shaped, and terminated with a pad, 55, that rests against the player's hand just below the joint of the index finger and against which counter-rotational force is applied both to support the flute and to resist its inadvertent rotation.

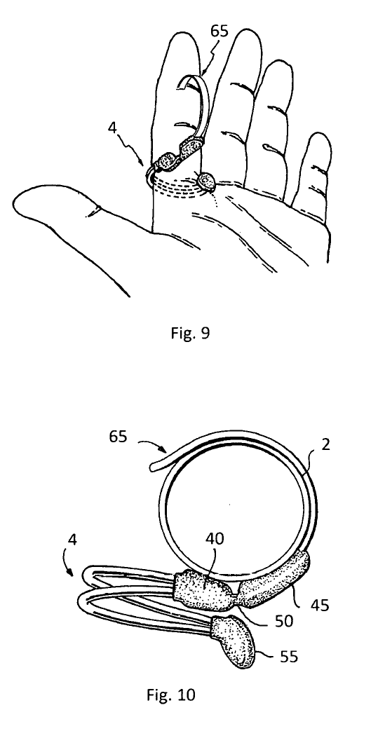

FIG. 8 is a detailed view of the portion of FIG. 7 showing the connection of the elastic band, unconnected at one end, 30, onto the device, which, after encircling the body of the flute, 2, provides tension between the device and the flute to securely attach it. This tensioned connection is by provision of a hole in the end of the elastic band which fits over a peg, 60, which is attached to the pad, 40, or to another part of the device as may be convenient, providing for its secure and easily removable attachment to the flute. Alternatively, the elastic band could be replaced by, for example, a cable tie or hook and loop arrangement.

FIG. 9 is a perspective view of the device mounted on the player's hand, absent the flute. In this embodiment, the flute attachment part, 65, is not an elastic band but a partial, more than 180 degree, ring made of an elastic memory-retention material such as spring metal or plastic and sized to be slightly smaller than that part of the body of the flute which it will partially encircle. Thus, the attachment arm, 65, removably, but securely, affixes the device to the flute by snapping around part of the flute's circumference.

FIG. 10 is a detailed side view of the device of FIG. 9 attached to the flute. The attachment is by the memory-retaining clip, 65, which only partially encircles the tubular body of the flute, 2, providing tensioning-force to the body of the flute and thence from the flute to the friction-generating pads, 40 and 45, holding the device in place. This permits the player to more easily pick up and put down the flute by inserting or removing their left hand index finger from the finger retainer, 4.

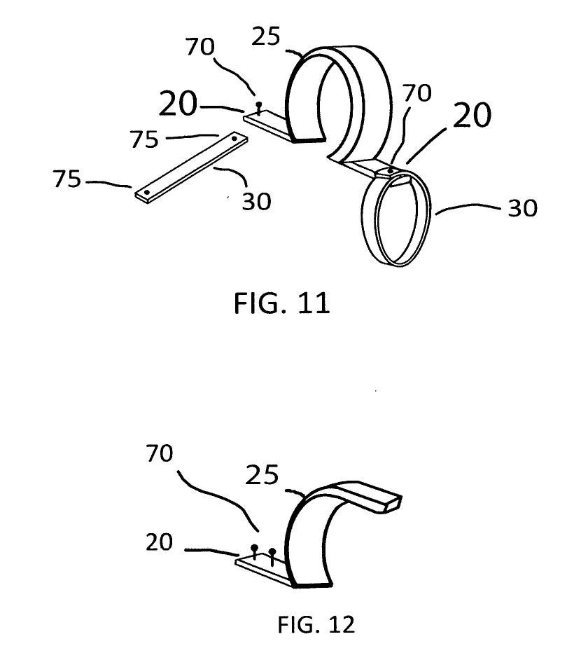

FIG. 11 is an environmental perspective view of the device configured as in FIG. 3, but with provision for detachable elastic bands, 30, of a length shorter than the circumference of the tubular flute body, so as to provide proper tension to firmly affix the device to the flute when encircling the body of the flute and attached to the device by both of the elastic bands' ends. The elastic bands fasten to the spacing bars, 20, by means of holes, 75, at each end of the bands that mount on corresponding pegs on the spacing bars, 70. In this view, at the near end of the device, an attachment band is mounted as it would be in operation after encircling the circumference of the body of the tubular flute. At the far end, an elastic band is shown resting on its side, unattached, to show the mounting peg, 70, on its spacing bar, 20, on the far end of the flute-finger connector. This embodiment of the flute-finger connector accommodates elastic bands of different lengths, or longer length bands with several properly situated holes, to be used to firmly affix the device to flutes of various sizes, such as bass, alto, piccolo, treble, etc., in addition to more common C flutes. If several pegs are provided on spacing bars of somewhat greater length, then these attachment points can be varied along the length of the flute so as to accommodate differing key configurations.

FIG. 12 is an environmental perspective view of the device configured as in FIG. 11, but with only a single spacing bar, 20, and two pegs that allow its attachment to flute with two elastic bands, as in FIG. 11, 30, and not shown here. This device has several advantages. First, if the partial finger connecting ring is made of malleable material, it can easily be bent to fit a wide variety of players' fingers. Second, it permits very quick entry and exit from the device. As above, the spacing bar can be made of various lengths, provided with different numbers of pegs, or made without any pegs so as to allow for its fastening to the flute via an extraneous fastener, such hook and loop, cable ties, etc. This partial ring can be made more or less complete to best fit a player's left hand index finger.

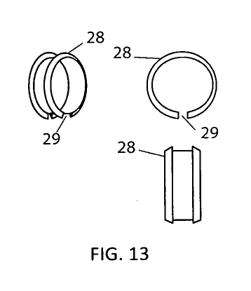

FIG. 13 shows one method by which the size of the flute-finger connector finger retainer may be adjusted. Shown are several views of rings that, properly sized, and with a proper gap at the bottom, 29, can be inserted into the finger retaining ring of the flute-finger connector and thereby reduce its diameter. Thus, an oversized finger-retaining partial ring, together with a variety of such inserts permits proper fitting of the device to many different player's hands.

While the invention has been described with reference to particular example embodiments it is intended to cover all modifications and equivalence within the scope of the following claims.

1. An attachment for flutes having a round tubular flute body formed with tone holes and/or finger keys, comprising:
a removable attachment, a flute-finger connector or finger retainer, comprising:
a discontinuous ring which partially encircles the player's left hand index finger to partially immobilize and solidly connect it to the flute, thereby providing rotational, horizontal, and vertical stabilizing support of the flute by the player while not impeding the player's left hand index finger's performance of its functions as pivot point, pressure point, and operating finger;
and spacing bars and attachment arms, for fastening onto the round tubular flute body for retention to the flute body;
which is removable and relocatable along and around the tubular body of the flute;
said finger retainer and spacing bars being discontinuous where the player's left hand index finger lies against the flute so that when playing the flute the player's left hand index finger rests directly against the body of the flute, and with the same orientation to the flute as if the invention were not attached to it.

2. The flute-finger connector of claim 1, which attaches to the body of the flute with a clamping mechanism.

3. The flute-finger connector of claim 1, comprising a thumb tip retainer for the flute player's right hand thumb, and spacing bars and attachment arms for fastening it onto the round tubular flute body where the thumb rests against the flute when playing it.

4. The flute-finger connector of claim 1, comprising a discontinuous ring and spacing arms, which can be removably affixed to the body of the flute by use of an extant extraneous attachment device that fully, or partially, and firmly encircles the circumference of the tubular flute body, including hook and loop, peg and hole, or cable ties.

5. The flute-finger connector of claim 1, wherein the finger retainer wraps around the player's left hand index finger to rest, via a pad, against the player's hand just below the index finger/hand joint and which rests against the body of the flute via a pad, and which is removably attachable to the flute by a partial ring of memory retaining material of a circumference of less than 360 degrees, which partially encircles the tubular body of the flute and has a diameter smaller than the flute's body, providing both support for the flute and resistance to the flute's inadvertent movement.

6. The flute-finger connector of claim 5, wherein the finger retainer wraps around the player's left hand index finger to rest, via a pad, against the player's left hand just below their index finger/hand joint and which rests against the body of the flute via a pad, which is removably attachable to the flute by an elastic band, of a length less than the circumference of the flute's body, that wholly encircles the tubular body of the flute and which removably attaches at one or both ends to the invention, providing both support for the flute and resistance to the flute's inadvertent movement.

7. The flute-finger connector of claim 1, comprising a discontinuous ring and spacing bars, which removably fastens to the flute with elastic rubber bands, of a length less than the circumference of the flute's body, which encircle the flute's body and attach to the spacing bars of the reinvention by provision of holes in the both ends of the elastic bands and mounting pegs on the spacing bars.

8. The flute attachment of claim 7, wherein only one spacing bar is provided.

9. The flute-finger connector of claim 1, wherein said ring-like opening is of adjustable circumference.

10. The flute attachment of claim 1, wherein the finger retaining ring can receive discontinuous rings of varying thickness, which allows the diameter of the finger-retaining discontinuous ring to be adjusted.
